(19) United States
(12) Patent Application Publication
(10) Pub. No.: US 2017/0070518 A1
(43) Pub. Date: Mar. 9, 2017

(54) ADVANCED PERSISTENT THREAT IDENTIFICATION

(71) Applicant: Trend Micro Incorporated, Tokyo (JP)

(72) Inventors: Pratyusa K. MANADHATA, Princeton, NJ (US); William G. HORNE, Princeton, NY (US)

(73) Assignee: Trend Micro Incorporated, Tokyo (JP)

(21) Appl. No.: 15/355,592

(22) Filed: Nov. 18, 2016

Related U.S. Application Data
(63) Continuation of application No. PCT/US2014/039406, filed on May 23, 2014.

(51) Int. Cl. H04L 29/06

(52) U.S. Cl. CPC H04L 63/1416; H04L 63/1425; H04L 63/0227

(57) ABSTRACT

Various apparatuses and methods are usable to identify an Advanced Persistent Threat (APT). Various network packets may be subjected to a suitable behavioral analysis to identify such APTs. Upon identifying an APT, a response is initiated which may include sending attack messages to various devices in the network.

### CROSS-REFERENCE TO RELATED APPLICATION

This application is a continuation of International Application No. PCT/US2014/039406, with an International Filing Date of May 23, 2014, which is incorporated herein by reference in its entirety.

### BACKGROUND

Computer networks are susceptible to being compromised by external agents for malicious purposes. A “vulnerability” is a flaw in software or hardware that makes such software or hardware vulnerable to attack. An “exploit” (e.g., viruses, worms, Trojans, bots, etc.) is software that takes advantage of a vulnerability to do something malicious to the vulnerable software or hardware. A “signature” is a pattern of bytes that can be used to identify an exploit. An attack is the use of an exploit against a vulnerability. Accordingly, armed with a signature for an exploit, a defender can block the exploit from reaching the vulnerability.

A “0-day” attack is the first time an exploit against a vulnerability has been used. Prior to such a first time attack, it may not even be known that the software or hardware has a vulnerability. The exploit has never been seen before, so no signature exists for that exploit. As a result, it may not be possible to defend against 0-day attacks using signature-based methods (e.g., viruses, worms, Trojans, bots, etc.).

### BRIEF DESCRIPTION OF THE DRAWINGS

For a detailed description of various examples, reference will now be made to the accompanying drawings in which:

FIG. 1 shows a network in accordance with an example;

FIG. 2 illustrates an APT Identification and Response System in accordance with an example;

FIG. 3 illustrates another APT Identification and Response System in accordance with an example;

FIG. 4 shows a method in accordance with an example;

FIG. 5 shows a method of identifying an APT in accordance with an example; and

FIG. 6 shows a method of identifying data exfiltration resulting from an APT in accordance with an example.

### DETAILED DESCRIPTION

Certain terms are used throughout the following description and claims to refer to particular system components. Different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection (wired, optical, wireless, etc.). Thus, if a first device couples to a second device, that connection may be through a direct connection or through an indirect connection via other devices and connections.

An example of a 0-day attack is an Advanced Persistent Threat (APT). An APT infects a network, performs a discovery of the internal machines in the network and exfiltrates confidential data and does all of this with exploits for which there are no known signatures. Exfiltrating data means to transmit data from the network to a destination outside the network (e.g., for theft purposes). The signatures for which signature-based detection software (e.g., antivirus software) attempts to detect generally do not exist in for an APT. That is, APTs often have no particular signature which could otherwise be used in their identification. As such, signature-based detection software generally is impotent to detect, much less mitigate, an APT.

Reference is made below to the identification of an advanced persistent threat (APT) in a network. An APT is also referred to herein as an APT attack. Logic is described below that indicates whether it is likely that an APT attack has occurred. That is, the logic may not determine with 100% certainty that an APT attack has indeed occurred, rather that it is more likely than not that an APT attack has occurred. Any reference herein to the identification of an APT includes detecting an APT or at least determining that an APT is likely to be occurring.

The techniques disclosed herein make use of network devices such as Intrusion Detection System (IDS) devices and/or Intrusion Prevent System (IPS) devices. Such network devices may be distributed throughout a network with some network devices being at the “edge” of the network and other network devices not being at the edge of the network (e.g., being in the core of the network). The “edge” of a network refers to the entry point into the network through which packets are received by the network as well as the exit point for which outgoing packets are transmitted by the network. The “core” of the network refers to all nodes, computers, switches, etc. that are internal to the network and not at the edge.

The network devices (e.g., IDS devices and/or IPS devices) filter network packets to identify packets that may be indicative of malicious activity such as a virus. The network devices are configured to address such detected malicious activity (e.g., by generating an alert, dropping a packet, etc.). All other packets (packets not identified by the network devices as possibly being infected with a virus) are sent to a centralized logic element, referred to herein as the APT Identification and Response System. The APT Identification and Response System may perform a behavioral analysis on such received packets to identify an APT and to identify attempted exfiltration of data from the network as a result of an APT.

Once an APT is identified, the APT Identification and Response System may send an alert to a security management system (SMS). The SMS is a control interface to configure the various IPS and IDS devices. Through the SMS, the APT Identification and Response System can broadcast attack response messages to the IPS and IDS devices to mitigate the attack. The SMS 120 generally provides “real-time” APT responses. That is, when the APT Identification and Response System identifies an APT, a response to the APT can occur using the SMS 120 immediately thereafter (e.g., within about one second).

A network machine (e.g., client computer, server, etc.) infected with an APT exhibits certain behavior. An APT attack generally includes three phases: (1) infiltration or initial infection whereby the attacker infiltrates an enterprise network using advanced malware, e.g., to initiate a 0-day exploit, (2) a discovery phase in which the attacker looks for a particular target inside the network, and (3) a data exfiltration phase during which certain data from the discovered target is exfiltrated from the network to the attacker. During these phases, the APT may be in constant touch with the attacker or a remote controller (external to the network).

An APT often carries out the attack over well-known network protocols. For example, communication with the remote controller may happen via a domain name service (DNS) and data exfiltration happens over open protocols such as DNS, hyper-text transport protocol (HTTP), and hyper-text transport protocol secure (HTTPS). The APT Identification and Response System analyzes relevant network traffic, e.g., DNS traffic and HTTP(S) traffic, in near real-time to provide hints about the occurrence of the phase 1 (initial infection), and to detect the occurrences of phases 2 (discovery) and 3 (data exfiltration). That is, an APT typically exhibits certain behaviors in terms of how the APT works and its communications back to the remote controller controlling the APT. The APT Identification and Response System performs a behavioral analysis on the network packets specifically attempting to detect behaviors characteristic of an APT.

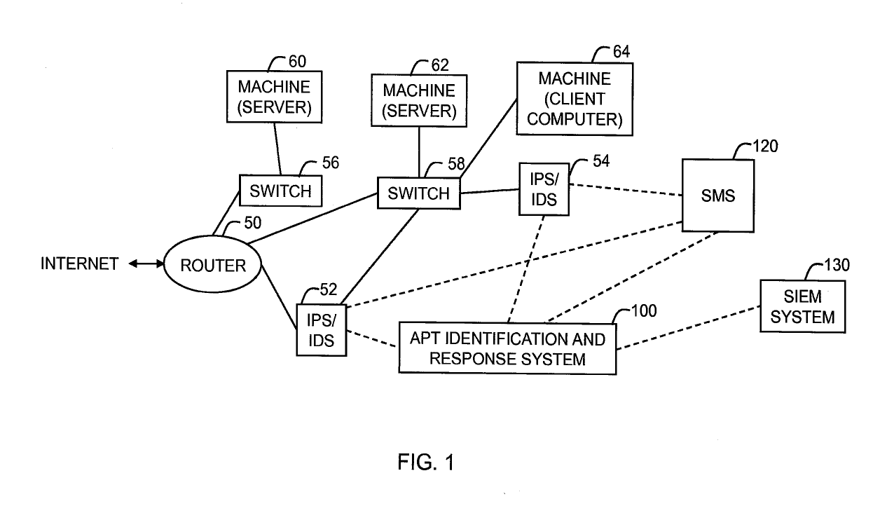

FIG. 1 illustrates an example of a network including an APT Identification and Response System 100. The illustrative network includes a router 50 which is at the edge of the network and provide connectivity between the network and external network such as the Internet. All elements shown in FIG. 1 besides router 50 are not at the edge of the network and are in the core of the network. The solid connecting lines in FIG. 1 represent physical connections and the dashed lines represent data flow.

Router 50 is shown coupled to switches 56 and 58. Switch 56 in turn is coupled to a machine 60. The term “machine” in this disclosure refers to any type of device in the network. Examples of machines include servers (as in the case of machine 60), client computers, storage devices, switches, etc. Switch 58 is coupled to machine 62 (server) and machine 64 (client computer).

FIG. 1 shows a plurality of network devices which include devices 52 and 54. Each of these devices is designated as “IPS/IDS”. That means that device 52 may be an IPS device or an IDS device. An IDS device is a device that monitors network traffic (e.g., by snooping the network busses) for potentially malicious activity or policy violations and produces reports of such activity or policy violations. Other systems may access the reports and take whatever remediation steps are deemed indicated. That is, an IDS device does not prevent an intrusion or otherwise take remediation actions itself. An IDS may examine network packets for certain predefined signatures. An IDS may have access to a database of signatures from known malicious threats.

Like an IDS device, an IPS device may also examine packets for certain signatures indicative of a malicious activity. However, an IPS device goes one step further than just detecting the malicious activity. An IPS device also attempts to block or stop the malicious activity. An IPS device may send an alarm, drop a packet deemed to be malicious in nature, reset a network connection, and/or block network traffic from an offending internet protocol (IP) address. Each of the IDS/IPS device 52, 54 are hardware devices that may have software running thereon on to cause the hardware to implement the intrusion detection and prevent functionality.

The IPS/IDS devices (e.g., devices 52, 54) may be placed virtually anywhere in the network. Some network devices may be at the edge of the network while other network devices may in the core of the network. IPS/IDS device 52 is connected to router 50 and thus is an example of a network device located at the edge of the network. IPS/IDS device 54 is connected to internal switch 58 and thus is an example of network device located in the core of the network.

FIG. 1 further illustrates an SMS 120. The SMS 120 provides a management control interface by which the various IPS/IDS devices 52, 54 can be configured. Each IPS/IDS device 52, 54 can be provided with a policy generated by the SMS 120 which specifies which signatures the IPS/IDS device is to detect, which types of packets are to be analyzed, the response to a detected malicious packet (in the case of an IPS device), etc. The SMS 120 can configure each IPS/IDS device with a different policy than other IPS/IDS devices. The SMS 120 also has a data path to the APT Identification and Response System 100.

A security information and event management (SIEM) system 130 is also shown in FIG. 1 which has data connectivity to the APT Identification and Response System 100. The SIEM system 130 collects events. An event may be a message that indicates any of a variety of activities. For example, an event may be that someone has logged into the network or a particular service hosted on the network at a certain time or that data was transmitted from a certain source machine or service to a certain destination machine. The APT identification and response system 100 may send events to the SIEM 130 to have the SIEM 130 analyze such messages at a later point in time (i.e., not necessarily in real-time). These events may encode that the network or a particular machine on the network is under attack by an APT. The messages may be used by the SIEM to facilitate the launch of an investigation by, for example, network security specialists into the source of the APT.

The various machines (e.g., machines 60-64) are able to communicate with one another and with locations/domains outside the network.

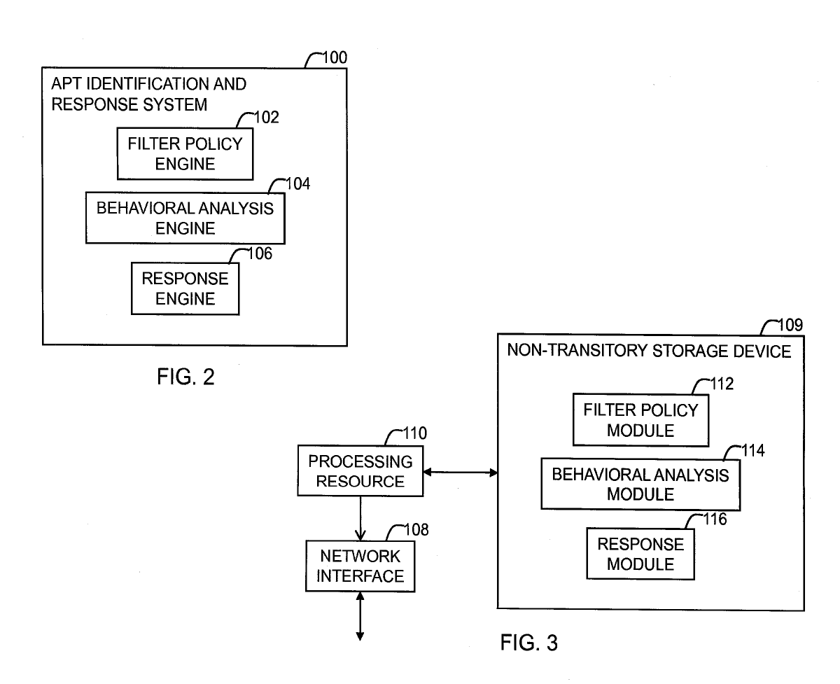

FIG. 2 shows an example of the APT Identification and Response System 100. In this example, the APT Identification and Response System 100 includes a filter policy engine 102, a behavioral analysis engine 104, and a response engine 106. The functions performed by these engines are further described below.

FIG. 3 illustrates another example of the APT Identification and Response System 100. This example includes processing resource 110 coupled to a network interface 108 and a non-transitory storage device 109. The processing resource 110 may include a single hardware processor, a plurality of hardware processors, a single computer, a plurality of computers, or any other type of processing resource. The network interface provides the network connectivity on behalf of the APT Identification and Response System 100 thereby permitting the APT Identification and Response System 100 to communicate with the various network devices (e.g., IPS/IDS devices 52, 54) as well as the SMS 120 and ESM 130.

The non-transitory storage device 109 may include volatile memory (e.g., random access memory), non-volatile storage (e.g., hard disk drive, optical storage, flash memory, etc.), or combinations thereof. The non-transitory storage device 109 includes a filter policy module 112, a behavioral analysis module 114, and a response module 116. Each module 112-116 may include instructions that are executable by the processing resource 110.

Each engine 102-106 of FIG. 2 is implemented as the processing resource 110 executing a corresponding module 112-116. Thus, the filter policy engine 102 is the processing resource 110 executing the filter policy module 112. Similarly, the behavioral analysis engine 104 is the processing resource 110 executing the behavioral analysis module 114. The response engine 106 is the processing resource 110 executing the response module 116. References below to functionality performed by a particular engine 102-106 apply equally to the processing resource 110 executing the corresponding module 112-116.

As illustrated in the example of FIG. 1 and described above, the APT Identification and Response System 100 has data connectivity to the various IPS/IDS devices 52, 54. The APT Identification and Response System 100 can configure the IPS/IDS devices 52, 54 as may be useful for the identification of APTs. For example, the APT Identification and Response System 100 may configure the IPS/IDS devices to send all DNS requests and corresponding responses that they encounter and/or to send all HTTP header packets.

During operation, as the various IPS/IDS devices 52, 54 encounter packets that correspond the types of packets and information that the APT Identification and Response System 100 has indicated to be of interest, the IPS/IDS devices 52, 54 send such packets to the APT Detection and Response System.

The APT Identification and Response System 100 receives the packets from the various IPS/IDS devices distributed throughout the network. The packets received by the APT Identification and Response System 100 may be packets that are sent to or received from a location external to the network and other packets transmitted internal to the network (e.g., between machines internal to the network), and generally may be packets that have not been determined to contain a virus by the network devices themselves. The APT Identification and Response System 100 then performs a behavioral analysis on the packets to identify an APT. Once an APT is identified, the APT Identification and Response System 100 may send a message to the SMS 120 which, in turn, creates an action for responding to the APT and sends messages to some or all IPS/IDS devices in the network to cause each such device to respond appropriately to the identified APT.

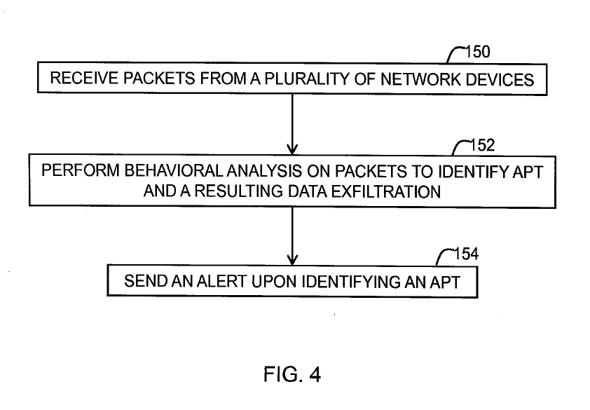

FIG. 4 shows an example of a method implemented by the APT Identification and Response System 100. At 150, the method includes receiving packets from a plurality of network devices. The network devices may include the IPS/IDS devices 52, 54 which may be distributed throughout the network. Some of the received packets were sent to or received from a location external to the network (e.g., DNS packets, DNS responses) and other packets may be transmitted internal to the network (e.g., from one machine in the network to another machine in the network).

At 152, the method includes the behavioral analysis engine 104 performing a behavioral analysis on the received packets to identify an APT. This operation may also include the identification of data exfiltration resulting from the APT.

At 154, the method includes, upon identifying an APT, sending an alert to the SMS 120 to cause the SMS 120 to distribute an attack response message to at least some of the network devices.

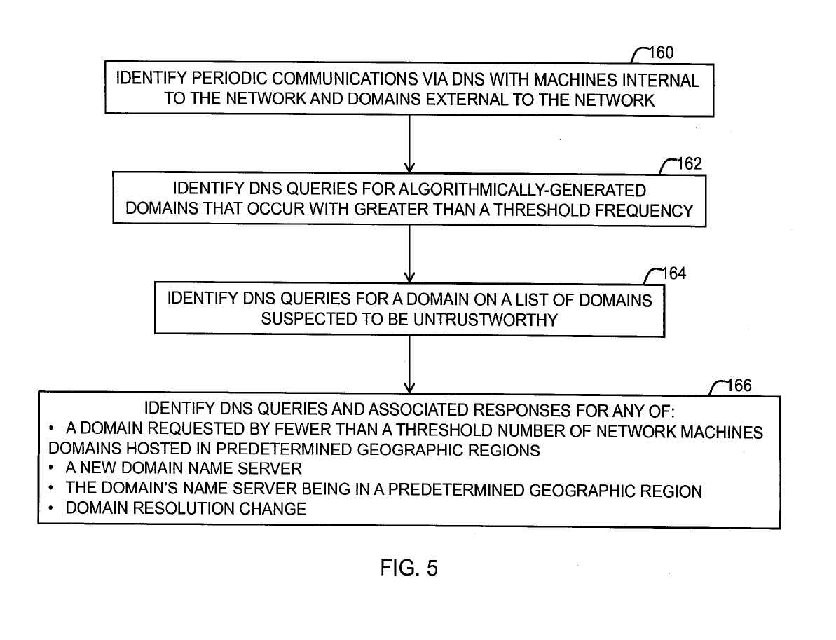

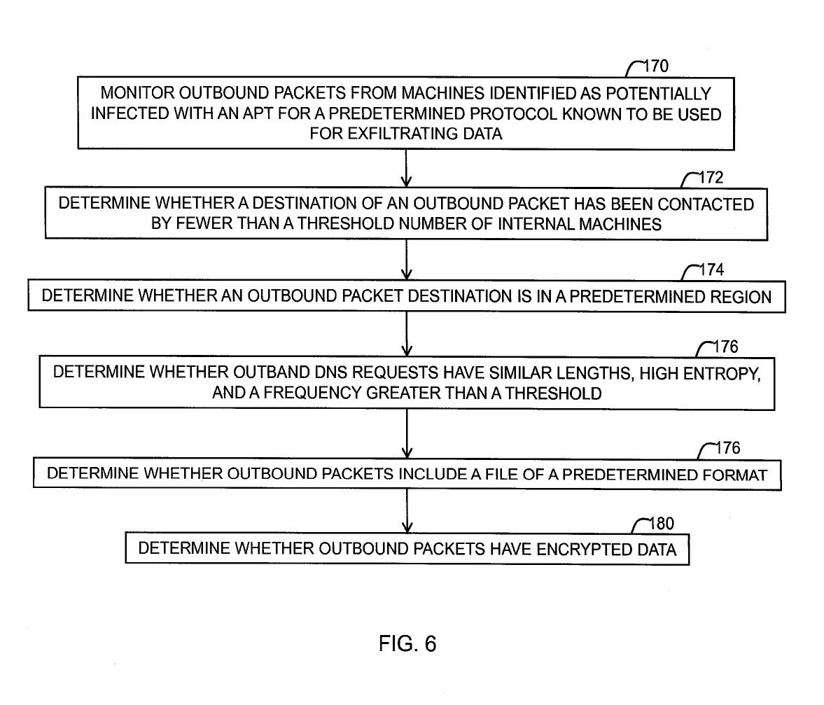

FIGS. 5 and 6 show examples of an implementation of operation 152 of FIG. 4 (performance of the behavioral analysis on the packets to identify an APT and a resulting data exfiltration). FIG. 5 shows an example of how the APT can be identified and FIG. 6 shows an example of how the data exfiltration can be identified.

As explained above, APTs are characterized by a lack of any particular signature that is otherwise characteristic of a virus. While it may be difficult to detect the initial infection of an APT into a network, APTs, however, tend to follow certain behaviors which can be detected by the APT Identification and Response System 100 after the initial infection. For example, an APT-infected machine may periodically contact other machines inside the network or a domain that acts as a remote controller for the APT. The APT Identification and Response System 100 can identify periodic accesses to internal machines and external suspicious domains from DNS requests and responses. In other cases, malware may exhibit bursty behavior by making DNS requests for many suspicious domains in a short period of time. The APT Identification and Response System 100 can identify suspicious domains in many ways, and FIG. 5 illustrates various ways to identify the APT.

Referring to FIG. 5, various operations are depicted, any one of which may be suitable to identify an APT. In some implementations, only one such operation need indicate an APT for the APT Identification and Response System 100 to pronounce the presence of an APT. In other implementations, more than one (e.g., two) such operations should positively indicate an APT for the APT Identification and Response System 100 to pronounce the presence of an APT.

In FIG. 5, the operations depicted can be performed in the order shown or in a different order. Further, additional or different APT-indicative operations may be included. These operations are performed on the packets received by the APT Identification and Response System 100 and, in some implementations by the behavioral analysis engine 104.

At 160, the APT identification method includes identifying periodic communications over a DNS with machines internal to the network and domains external to the network. A true APT may periodically communicate with a remote controller and may also periodically communicate a machine internal to the network to infect it. Operation 160 detects such activity which is indicative of an APT.

At 162, the method includes identifying DNS queries for algorithmically-generated domains that occur with greater than a threshold frequency (e.g., more than 100 per minute). Some APT attacks may result in the attempt to contact the APT controller outside the network (e.g., to report status, exfiltrate data, etc.) by automatically generating a domain name, using a DNS message to attempt to contact that generated domain name, and determining if the controller is present at the contacted domain name. If the controller is not present at that domain name, then the APT generates a different domain name and repeats the process. This iterative domain name and communication process continues until the APT successfully is able to locate the external APT controller. Such behavior thus is characterized by a large number of DNS messages in a short period of time. Thus, operation 162 attempts to detect such “bursty” DNS messaging.

At 164, the method includes identifying DNS queries for a domain on a list of domains suspected to be untrustworthy (e.g., a black list). Certain domain names may be known via various techniques and prior knowledge to be prior sources of possible viruses and APT attacks. Such domain names may be added to a black list and operation 164 identifies queries to such black-listed domain names.

At 166, the method includes identifying DNS queries and associated responses for any of:
A domain requested by fewer than a threshold number of network machines: A domain requested by fewer than a threshold number of network machines (i.e., relatively few machines) may be indicative of an APT attack because such domains would typically only be contacted by an APT attack, and not for legitimate reasons.
Domains hosted in predetermined geographic regions: Certain regions of the world may be known to be sources of cyber-security threats and thus attempted contacts from within the network to domains hosted in such suspicious regions may be indicative of an APT attack.
A domain's name server that is new: An older, well-known domain name server generally is not indicative of an APT attack, but a newer domain name server may be indicative of an APT attack.
The domain's name server (e.g., a DNS server) being in a predetermined geographic region: As explained above, certain regions of the world may be known to be sources of cyber-security threats and thus attempted contacts from within the network to domain name servers hosted in such suspicious regions may be indicative of an APT attack.
A domain resolution change: An APT attacker may first register a domain but the domain will not resolve to a legitimate IP address. Instead, the domain name will resolve to “NXDOMAIN” or 127.0.0.1. After a while, the attacker will assign a legitimate IP address to the domain and then the domain will begin resolving to the new IP address. By way of an additional example, a domain consistently may have resolved to a server in the U.S. for years. Then suddenly it starts resolving to a server in a different country. Such domain resolution changes may be indicative of an APT.

Once a machine has been identified as having been infected with APT (e.g., per the method of FIG. 5), the APT Identification and Response System 100 then identifies whether data exfiltration is occurring per the method of, for example, FIG. 6. Determining that data exfiltration is likely occurring provides increased confidence of the determination that an APT is underway.

In FIG. 6, the operations depicted can be performed in the order shown or in a different order. Further, additional or data exfiltration-indicative operations may be included. These operations are performed on the packets received by the APT Identification and Response System 100 and, in some implementations by the behavioral analysis engine 104.

As was the case for the method of FIG. 5 for identifying an APT, to identify data exfiltration, in some implementations only one operation listed in FIG. 6 need indicate data exfiltration for the APT Identification and Response System 100 to pronounce the presence of a data exfiltration in progress. In other implementations, more than one (e.g., two) such operations should positively indicate an occurring data exfiltration for the APT Identification and Response System 100 to pronounce the presence of data exfiltration.

At 170, the method includes monitoring outbound packets from machines in the network identified as potentially infected with an APT for a predetermined protocol known to be used for exfiltrating data from networks. An APT may attempt to exfiltrate data using a certain network protocol such as DNS, HTTP, or HTTPS. There may not be anything inherently wrong with the use of such protocols, but their use may be typical of data exfiltration by an APT attack.

At 172, the method includes determining whether a destination of an outbound packet has been contacted by fewer than a threshold number of machines internal to the network. APT-based data exfiltrations are rarer than legitimate outbound data packets. Thus, an outbound packet to a destination that is relatively infrequently contacted may be indicative of APT-based data exfiltration. This threshold may be hard-coded or user-configured.

At 174, the method includes determining whether a destination of an outbound packet is in a predetermined geographic region. As indicated above, certain geographic regions may not be trustworthy. Thus, outbound packets from a network to such locations may be indicative of APT-based data exfiltrations.

At 176, the method includes determining whether outbound DNS requests have similar lengths, high entropy, and a frequency greater than a second threshold. Some APT attacks exfiltrate the targeted data by sending the data in small chunks by way of outbound DNS requests. For example, a targeted data file may be exfiltrated one byte or a few bytes at time in a series of DNS requests. Instead of the data payload of the DNS request packets being a domain name to translate to an IP address, the data payload of DNS request packets includes a portion of the data to be exfiltrated. Such data exfiltration is characterized by a larger number of DNS request packets in a short period of time and packets that have a similar length and a relatively high value of entropy. The APT controller receives the numerous DNS, recovers the data bytes, and reassembles the piece-meal exfiltrated data back into the original file.

The APT Identification and Response System 100 thus detects the occurrence of a burst (e.g., more than a threshold number of such packets in a certain period of time—greater than a particular frequency) of outbound DNS request packets of the same or similar length and with high entropy. This threshold value also may be hard-coded or user-configurable.

At 178, the method includes determining whether outbound packets include a file having a predetermined format. Data exfiltration resulting from an APT tend to include files of a particular few file formats such as “zip” files, Roshal Archive (RAR) files, etc. There may not be anything inherently wrong with the use of such file formats, but their use may be typical of data exfiltration by an APT attack.

At 180, the method includes determining whether outbound packets include encrypted data. Data exfiltration resulting from an APT tend to include encrypted data.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A non-transitory storage device containing instructions that, when executed by a processing resource, causes the processing resource to:
receive packets from a plurality of network devices distributed throughout a network, some of the packets sent to or received from a location external to the network and other packets transmitted internal to the network;
perform a behavioral analysis on the received packets to identify an advanced persistent threat (APT); and
upon identifying an APT, send an alert to a centralized logic unit to cause the centralized logic unit to distribute an attack response message to the network devices.

2. The non-transitory storage device of claim 1 wherein the network devices include devices that are not at an edge of the network as well as devices that are at the edge of the network.

3. The non-transitory storage device of claim 1 wherein the instructions, when executed, cause the processing resource to perform the behavioral analysis to identify an APT by performing at least one:
identify periodic communications over a domain name service (DNS) with machines internal to the network and domains external to the network;
identify DNS queries for algorithmically-generated domains that occur with greater than a threshold frequency;
identify DNS queries for a domain on a list of domains suspected to be untrustworthy; and
identify DNS queries and associated responses for any of: a domain requested by fewer than a threshold number of network machines, domains hosted in predetermined geographic regions, a domain's name server that is new, the domain's name server being in a predetermined geographic region, and a domain resolution change.

4. The non-transitory storage device of claim 1 wherein the instructions, when executed, cause the processing resource to detect data exfiltration from an identified APT by performing at least one:
monitor outbound packets from machines in the network identified as potentially infected with an APT for a predetermined protocol known to be used for exfiltrating data from networks;
determine whether a destination of an outbound packet has been contacted by fewer than a first threshold number of machines internal to the network;
determine whether a destination of an outbound packet is in a predetermined geographic region;
determine whether outbound domain name service (DNS) requests have similar lengths, have high entropy, and have a frequency greater than a second threshold;
determine whether outbound packets include a file having a predetermined format; and
determine whether outbound packets include encrypted data.

5. The non-transitory storage device of claim 1 wherein the network devices include at least a plurality of intrusion prevention system devices and intrusion detection system devices.

6. The non-transitory storage device of claim 1 wherein the centralized logic unit includes a security management system which provides a control interface to configure the various IPS and IDS devices.

7. The non-transitory storage device of claim 1 wherein the instructions, when executed, cause the processing resource to cause a command packet to be sent to each network device, each command packet including a policy to be used by the receiving network device to filter packets.

8. The non-transitory storage device of claim 7 wherein the policy provided to one network device may be different than the policy provided to another network device.

9. A system, comprising:
a filter policy engine to generate policies for dissemination to a plurality of network devices distributed throughout a network;
a behavioral analysis engine to analyze filtered packets received from the network devices to identify an advanced persistent threat (APT) and a resulting data exfiltration; and
a response engine to respond to an identified APT by causing attack response messages to be sent to the network devices to command each such network device to respond to the identified APT in a manner dictated by the respective attack message.

10. The system of claim 9 wherein the behavioral analysis engine is to identify an APT by performing at least one of:
identifying periodic communications over a domain name service (DNS) with machines internal to the network and domains external to the network;
identifying DNS queries for algorithmically-generated domains that occur with greater than a threshold frequency;
identifying DNS queries for a domain on a list of domains suspected to be untrustworthy; and
identifying DNS queries and associated responses for any of: a domain requested by fewer than a threshold number of network machines, domains hosted in predetermined geographic regions, a domain's name server that is new, the domain's name server being in a predetermined geographic region, and a domain resolution change.

11. The system of claim 9 wherein the behavioral analysis engine is to detect the data exfiltration by performing at least one of:
monitoring the outbound traffic for a predetermined protocol known to be used for exfiltrating data from networks;
determining whether a destination of an outbound packet has been contacted by fewer than a first threshold number of machines internal to the network;
determining whether a destination of an outbound packet is in a predetermined geographic region;
determining whether outbound domain name service (DNS) requests have similar lengths, have high entropy, and have a frequency greater than a second threshold;
determining whether the outbound network traffic includes a file having a predetermined format; and
determining whether the outbound network traffic is encrypted.

12. The system of claim 9 at least one policy specifies a type of network protocol.

13. A method, comprising:
receiving packets from a plurality of network devices distributed throughout a network, some of the packets sent to or received from a location external to the network and other packets transmitted internal to the network;
performing a behavioral analysis on the received packets to identify an advanced persistent threat (APT) and a resulting data exfiltration; and
upon identifying an APT, sending an alert to a security management system (SMS) to cause the SMS to distribute an attack response message to at least some of the network devices.

14. The method of claim 13 wherein performing the behavioral analysis to detect the APT includes performing at least two of:
identifying periodic communications over a domain name service (DNS) with machines internal to the network and domains external to the network;
identifying DNS queries for algorithmically-generated domains that occur with greater than a threshold frequency;
identifying DNS queries for a domain on a list of domains suspected to be untrustworthy; and
identifying DNS queries and associated responses for any of: a domain requested by fewer than a threshold number of network machines, domains hosted in predetermined geographic regions, a domain's name server that is new, the domain's name server being in a predetermined geographic region, and a domain resolution change; and
wherein performing the behavioral analysis to detect the data exfiltration resulting from the APT includes performing at least two of:
monitoring the outbound traffic for a predetermined protocol known to be used for exfiltrating data from networks;
determining whether a destination of an outbound packet has been contacted by fewer than a first threshold number of machines internal to the network;
determining whether a destination of an outbound packet is in a predetermined geographic region;
determining whether outbound domain name service (DNS) requests have similar lengths, have high entropy, and have a frequency greater than a second threshold;
determining whether the outbound network traffic includes a file having a predetermined format; and
determining whether the outbound network traffic is encrypted.

15. The method of claim 13 further comprising:
transmitting a policy to each of the network devices according; and
filtering, by each network device, packets received by that network device according to the policy transmitted to that network device; and
wherein receiving the packets from the network devices include packets after said filtering has occurred.
